(19) United States
(12) Patent Application Publication
(10) Pub. No.: US 2010/0264040 A1
(43) Pub. Date: Oct. 21, 2010

(54) METHOD FOR CONCENTRATING PARTICLES OR MOLECULES AND APPARATUS THEREOF

(75) Inventors: SHAU-CHUN WANG, Chiayi City (TW); Hsueh-Chia Chang, Granger, IN (US); Hsiao-Ping Chen, Chiayi County (TW); Chun-Ming Chang, Changhua County (TW)

Correspondence Address: WPAT, PC;INTELLECTUAL PROPERTY ATTORNEYS, 2030 MAIN STREET, SUITE 1300, IRVINE, CA, 92614, US

(73) Assignee: NATIONAL CHUNG CHENG UNIVERSITY, Chia-Yi County (TW)

(21) Appl. No.: 12/826,717

(22) Filed: Jun. 30, 2010

Related U.S. Application Data
(63) Continuation of application No. 12/383,893, filed on Mar. 30, 2009.

(51) Int. Cl. B01D 43/00

(52) U.S. Cl. 205/766; 204/550; 977/882

(57) ABSTRACT

The present invention provides a method for concentrating particles or molecules and an apparatus thereof. The apparatus comprises a substrate, a conducting granule having nano-pores or nano-channels capable of permitting ion permeation, an electrolyte solution comprising counter-ions having an opposite electric property to the conducting granule, and an external field. Wherein, particles or molecules to be concentrated have an identical electric property as the conducting granule at a predefined pH value, and are added into the electrolyte solution with the predefined pH value. While the external electric field is applied across the reservoir where the conducting granule is sitting, the counter-ions exit from the nano-pores or nano-channels and such that a transient ion super-concentration phenomenon occurs at an ejecting pole on the conducting granule so as to concentrate the particles or molecules. Hence the present invention has potential application in bead-based molecular assays.

This application is a Continuation-In-Part of U.S. patent application Ser. No. 12/383,893, the entire contents of which are incorporated herein by reference.

### BACKGROUND OF THE INVENTION

1. Field of the Invention

This invention relates to a method for concentrating particles or molecules and an apparatus thereof, and particularly to a method and apparatus capable of trapping and concentrating particles or molecules in the microfluid and applicable to bead-based molecular assays.

2. Description of Related Art

Field-induced polarization of particles and molecules is responsible for a variety of electric particle and molecular forces that permit particle manipulation, drive colloid self-assembly, and allow suspension characterization. In electrolytes, there is considerable evidence that double-layer conduction around the particle, normal charging into the double-layer of thickness λ, and other polarization mechanisms involving currents, ion fluxes, electro-osmotic convection, and charge storage in double-layers are the more dominant polarization mechanisms than dielectric polarization. These double-layer polarization mechanisms are confined to the thin double-layers (of 10-100 nm) but nevertheless involve space charges. Empirical evidence for such double-layer polarization mechanisms includes the prevalence of the relaxation time aλ/D in many impedance and dielectrophoresis measurements which requires a conducting Stern layer. However, these lumped conductivity models do not capture local charge accumulation (capacitance) effects at certain locations within the double-layer.

A fluid used in micro-channel is known as a microfluid. In the recent decade, a microfluid system develops quickly since advantages including fewer samples needed, high sensibility, low cost, and manpower and time saving can be achieved after the system is miniaturized. Therefore, the microfluid system has been applied extensively in various fields, particularly in the bio-related field. However, most bio-samples are more precious and often have lower concentrations than the concentration of detection limit of the microfluid system. Accordingly, it is necessary to find a suitable micro-concentrating system to increase the concentration of the samples to the detection limit, so as to enhance the applicability of the microfluid system.

### SUMMARY OF THE INVENTION

With these and other objects, advantages, and features of the invention that may become hereinafter apparent, the nature of the invention may be more clearly understood by reference to the detailed description of the present invention, the embodiments and the several drawings herein.

The present invention provides a method and apparatus to concentrate particles or molecules by capturing local charge accumulation effects at a certain location within the double-layer on the surface of a conducting granule, and the method and apparatus are able to apply to bead-based biomolecular assays.

The present invention discloses a method for concentrating particles or molecules, comprising the following steps. Firstly, a substrate comprising a reservoir may be provided and a conducting granule may be disposed in the reservoir. The conducting granule may be negatively charged or positively charged and comprise nano-pores or nano-channels permeable to ions. Then, an electrolyte solution may be disposed in the reservoir and the electrolyte solution comprises counter-ions having an opposite electric property to the conducting granule. Next, particles or molecules to be concentrated may be added into the electrolyte solution. The particles or molecules have an identical electric property as the conducting granule at a predefined pH value. Then, by driving the particles or molecules across the granule with an electric field, the pH of the electrolyte solution may be adjusted to the predefined value at a rate according to the pl value or pKa value of the particles or molecules. When applying an external electric field across the two side-channels, the counter-ions may enter the conducting ion-selective granule. After passing through the granule, counter-ions offset the charge on the granule surface at an ejecting pole and decrease the electric field locally. The electric lines will converge at the ejecting pole and result in tangential flux, which brings more ions into the pole area. Due to the low diffusion, the counter-ions will accumulate to produce high charge density and attract opposite charge (co-ions) nearby to maintain electric neutrality, both counter-ions and co-ions super-concentration phenomenon may come up. The charged particles or molecules can be concentrated in this fashion. The method may be applicable to the bead-based biomolecular assay. If the nano-pore or nano-channel size of the conducting granule is too small, usually less than the 3-5 times the double-layer thickness, counter-ions may be trapped in the granule, hence result in poor concentration phenomenon. Therefore, the pore size of the nano-pores or nano-channels may be roughly 3-5 times or larger the double-layer thickness, and the sizes of the particles or molecules can be nano-scale or micro-scale.

The present invention further discloses an apparatus for concentrating particles or molecules. The apparatus may comprise a substrate which may comprise a reservoir; a conducting granule which may be neither negatively charged or positively charged and comprise nano-pores or nano-channels able to permit ion permeation, and be disposed in the reservoir; an electrolyte solution which may comprise counter-ions having an opposite electric property to the conducting granule, and be disposed in the reservoir; and an external electric field which may be applied on the conducting granule. Wherein, particles or molecules to be concentrated have an identical electric property as the conducting granule at a predefined and desired pH value and be added into the electrolyte solution. When the particles and molecules are driven repeatedly through the granule by the electric field, the electrolyte solution may be adjusted to the predefined pH value at a rate according to the pl value or a pKa value of the particles or molecules. While the external electric field may be applied on the conducting granule, the counter-ions may exit from the nano-pores or nano-channels and have a nonuniform concentration on the surface of the conducting granule such that a transient ion super-concentration phenomenon may occur at an ejecting pole on the conducting granule so as to concentrate the particles or molecules. Additionally, the substrate may comprise a chip or a plastic plate, and the particles or molecules may comprise fluorescence dye particles or micro-colloid particles. The apparatus may be applicable to a bead-based biomolecular assay.

This present invention may involve a transient hundred-fold to million-fold concentration of double-layer counter-ions at the ejecting pole of a millimeter-sized conducting nano-porous granule that permits ion permeation by applying a high-intensity electric field across the apparatus. The higher the number of charges of the particles or a dissociation degree of the molecules in the electrolyte solution, a concentration effect of the particles or molecules is better. In addition, the concentration effect of the particles or molecules in independent of viscosity thereof.

The present invention also discloses the mechanism behind the transient ion super-concentration phenomenon at the ejecting pole and demonstrates that a two-order to six-order enhancement in the particle or molecule concentration may be achieved locally if the conducting granule is permeable to ions. The dynamic super-concentration phenomenon may be attributed to a unique counter-ion screening dynamics that transforms half of the surface field into a converging one towards the ejecting pole. The resulting surface conduction flux may then funnel a large upstream electro-osmotic convective counter-ion flux into the injecting hemisphere towards the zero-dimensional gate of the ejecting hemisphere to produce the super-concentration. Wherein, when the pore size of the conducting granule may be roughly 3-5 times or larger the electrolyte concentration-dependent double-layer thickness, the super-concentration may happen. As the concentrated counter-ion is ejected into the electroneutral bulk electrolyte, it attracts co-ions (i.e. particles or molecules having an identical electric property as the conducting granule) and produces a corresponding concentration of the co-ions.

In the present invention, the above-mentioned mechanism is also shown to trap and concentrate co-ion microcolloids which are larger than the nano-pore or nano-channel dimension of the conducting granule. The micro-colloids may be not expected to enter into the conducting granule. However, co-ion micro-colloids can still be attracted to the concentrated counter-ions at the ejecting pole. Bead-based biomolecular assays have attracted considerable attention recently and the possibility of filtering and concentrating such functionalized or hybridized beads on a chip can be quite useful for such assays.

### BRIEF DESCRIPTION OF THE DRAWINGS

The exemplary embodiments of the present invention will be understood more fully from the detailed description given below and from the accompanying drawings of various embodiments of the invention, which, however, should not be taken to limit the invention to the specific embodiments, but are for explanation and understanding only.

FIG. 1 illustrates a schematic diagram of a mechanism behind a transient ion super-concentration phenomenon in accordance with the present invention;

FIG. 2 illustrates a flowchart of a method for concentrating particles or molecules in accordance with the present invention;

FIG. 3 illustrates a schematic diagram of an apparatus for concentrating particles or molecules in accordance with one embodiment of the present invention;

FIG. 4 illustrates a schematic diagram of a fluorescence microscopy imaging apparatus in accordance with one embodiment of the present invention;

FIG. 5 illustrates sequential images of solute concentration evolution for a cation exchange resin granule in accordance with one embodiment of the present invention;

FIG. 6 illustrates a concentration intensity contour in the region highlighted in FIG. 5 in accordance with the present invention;

FIG. 7 illustrates a measured concentration factor in a jet area at different electrolyte concentrations for cation exchange resin granules and for wax beads in accordance with one embodiment of the present invention;

FIG. 8 illustrates a polar ejection for an anion exchange granule in accordance with one embodiment of the present invention; and

FIG. 9 illustrates sequential images of microparticle concentration evolution for a cation exchange resin granule in accordance with one embodiment of the present invention.

### DETAILED DESCRIPTION OF THE PREFERRED EMBODIMENTS

Exemplary embodiments of the present invention are described herein in the context of a method for concentrating particles or molecules and an apparatus thereof.

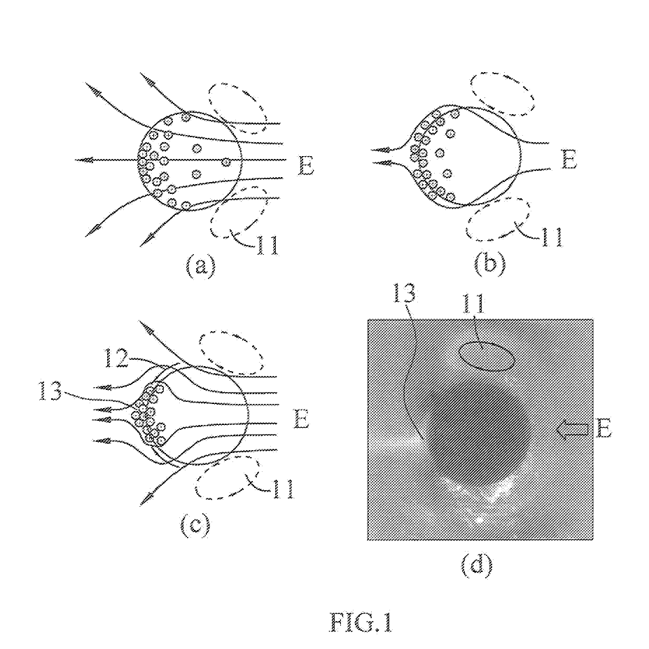

Referring to FIG. 1, a schematic diagram of a mechanism behind a transient ion super-concentration phenomenon in accordance with the present invention is illustrated. To concentrate space charges within a double-layer at an ejecting pole, a converging tangential flux from a conducting granule toward the ejecting pole must be implemented as normal charging into this small polar region is insignificant. The requisite tangential field at the ejection hemisphere is produced by the screening effects of exiting counter-ions from the saturated granule, as seen in FIG. 1. A tangential counter-ion flux results at the ejecting hemisphere that must be sustained by an equally large tangential flux at the injecting hemisphere under the condition when the conducting granule is permeable and cannot accumulate ions. Consequently, ion fluxes into and out of the conducting granule are required for large polar concentration. As a general rule, pores with radii smaller than the double layer thickness tend to trap large amounts of counter-ions and would not release them to the exit hemisphere. This important pore size effect for super-concentration will be established hereinafter in the present invention. In detail, FIG. 1 shows the conducting granule funnel: (a) convective charging of the conducting granule by asymmetric vortices 11 at the right, (b) saturation of double layer by counter-ions exiting the conducting granule and field screening, and (c) dynamic double-layer pinching 12 towards the ejection pole 13. FIG. 1(d) is a real image showing the polar ejection 13 and the asymmetric vortices 11 on the other hemisphere. One vortex 11 evidenced from the streak is highlighted.

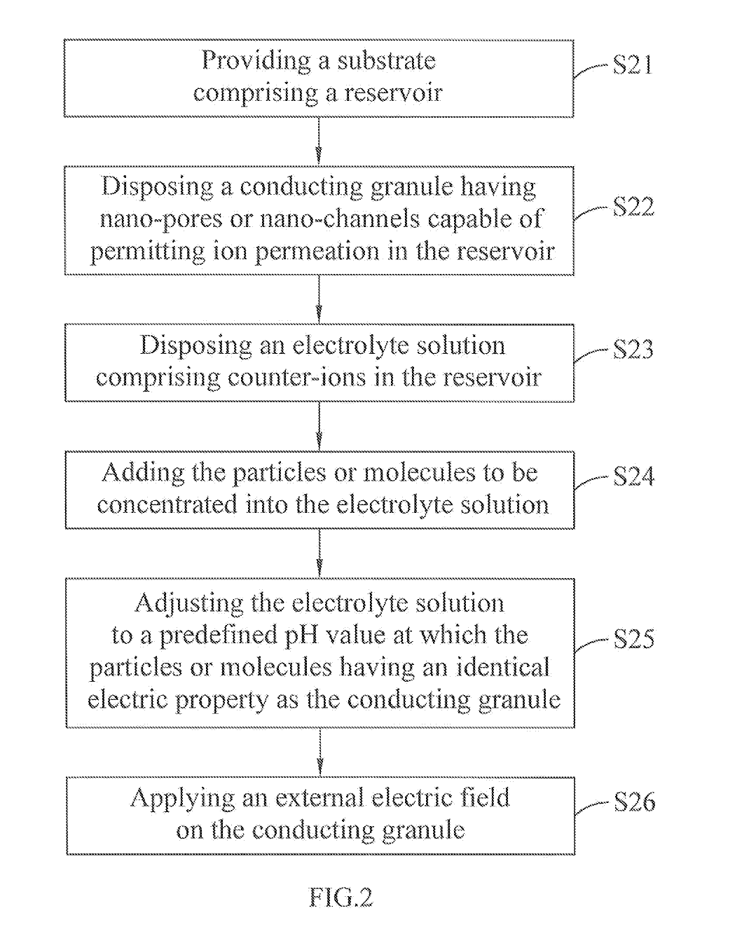

Referring to FIG. 2, a flowchart of a method for concentrating particles or molecules in accordance with the present invention is shown. The method may comprise the following steps: step S21, providing a substrate comprising a reservoir; step S22, disposing a conducting granule in the reservoir, the conducting granule being negatively charged or positively charged and comprising nano-pores or nano-channels capable of permitting ion permeation; step S23, disposing an electrolyte solution in the reservoir, the electrolyte solution comprising counter-ions having an opposite electric property to the conducting granule; step S24, adding the particles or molecules to be concentrated into the electrolyte solution, the particles or molecules having an identical electric property as the conducting granule at a predefined pH value; step S25, adjusting the electrolyte solution to the predefined pH value according to a pl value or a pKa value of the particles or molecules; and step S26, applying an external electric field on the conducting granule. While the external electric field is applied on the conducting granule, the counter-ions exit from the nano-pores or nano-channels and have a nonuniform concentration on a surface of the conducting granule so as to occur a transient ion super-concentration phenomenon at an ejecting pole on the conducting granule.

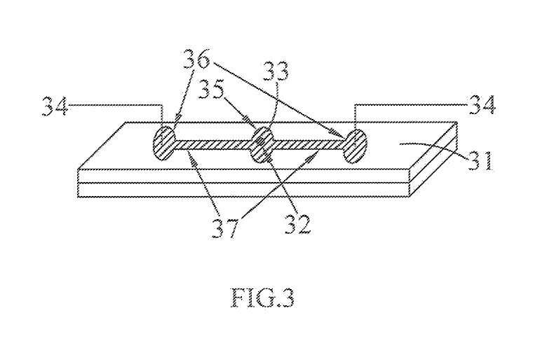

Referring to FIG. 3, a schematic diagram of an apparatus for concentrating particles or molecules in accordance with one embodiment of the present invention is shown. The apparatus may comprise a substrate such as a chip, a conducting granule 32, an electrolyte solution 33, and an external electric field 34. The substrate 31 may comprise a center reservoir and two side reservoirs 36 and the center reservoir 35 may link to the two side reservoirs 36 by connection channels 37. The conducting granule 32 may be negatively charged or positively charged and comprise nano-pores or nano-channels permeable ions, and be disposed in the center reservoir 35. The electrolyte solution 33, such as Tris buffer solution, may comprise counter-ions having an opposite electric property to the conducting granule 32 and be disposed in the reservoirs 35 and 36. The external electric field 34 is produced by a pair of electrodes. Wherein, the particles or molecules are have an identical electric property as the conducting granule 32 at a predefined pH value and are added into the electrolyte solution 33, and while the external electric field 34 is applied on the conducting granule 32, the counter-ions exit from the nano-pores or nano-channels and have a nonuniform concentration on the surface of the conducting granule 32 such that a transient ion super-concentration phenomenon occurs at an ejecting pole on the conducting granule 32 so as to concentrate the particles or molecules.

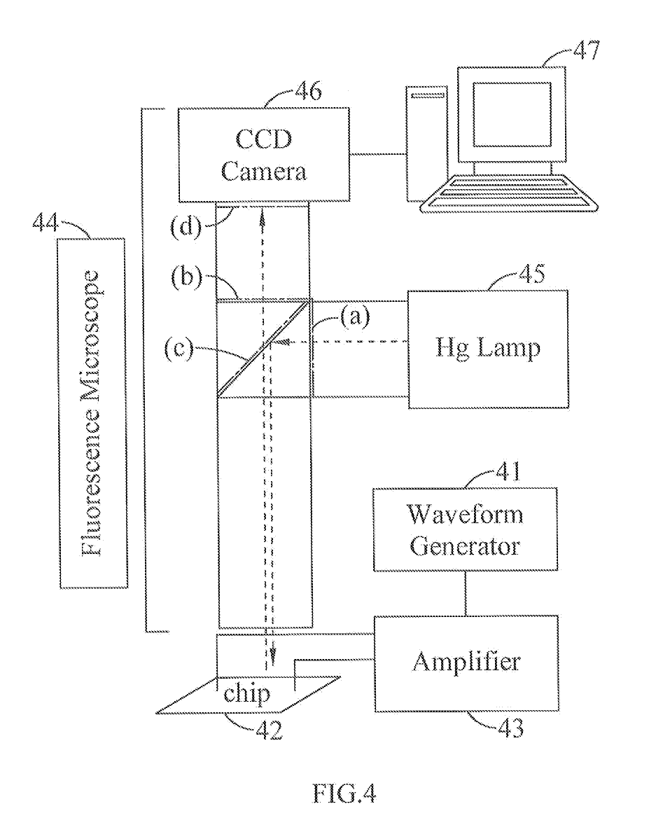

We image the enhanced counter-ion concentration not by, for example, counter-ion dye molecules, which may be strongly absorbed to immobilize on the granule prior to entering the nano-pores or nano-channels, but, for example, by fluorescence co-ion dye molecules which may neutralize the counter-ions at the exit of the conducting granule and whose concentration is correspondingly enhanced at that location. An external electric field of about 100 V/cm may be applied on the millimeter-sized conducting granule made of polystyrene resins by a pair of electrodes. The pore size of the conducting granule may be 65 nm, or roughly 3-5 times or larger the double-layer thickness of more concentrated buffer solutions (also as electrolyte solutions) (>0.1 mM). The conducting granule can be either negatively charged (e.g. cation exchange resin granule) or positively charged (e.g. anion exchange resin granule). Fluorescence dye solution of cation (e.g. rhodamine B, rhodanmine110) or anion (e.g. fluorescein, sulforhodamine110) in 10 mM pH buffers is filled in the reservoir prior to the field application. Net charges (mostly counter ions) released from the conducting granule are immediately neutralized by co-ions (i.e. particles or molecules having an identical electric property as the conducting granule) in the bulk in a region close to the conducting granule. Since co-ions as fluorescence dyes are employed to illuminate the phenomenon, an ejection reflects a local increase in the concentration in the neutral bulk close to the conducting granule. The images are digitized and transferred into graphic analysis software, as shown in the FIG. 4. In the figure, a waveform generator 41 produces an external electric field to a chip 42 via an amplifier 43, and then fluorescence dye solution is illuminated by a fluorescence microscope 44 with a mercury lamp 45 as a light source. The emitted fluorescence is detected with a charge-coupled device (CCD) camera 46 by recording the images of the process. After that, the images are digitized and transferred into graphic analysis software by a computer 47. Wherein, fluorescence microscopy imaging apparatus further comprises an excitation filer (a), an emission filer (b), a dichromatic mirror (c), and a 510 nm-530 nm bandpass filter (d).

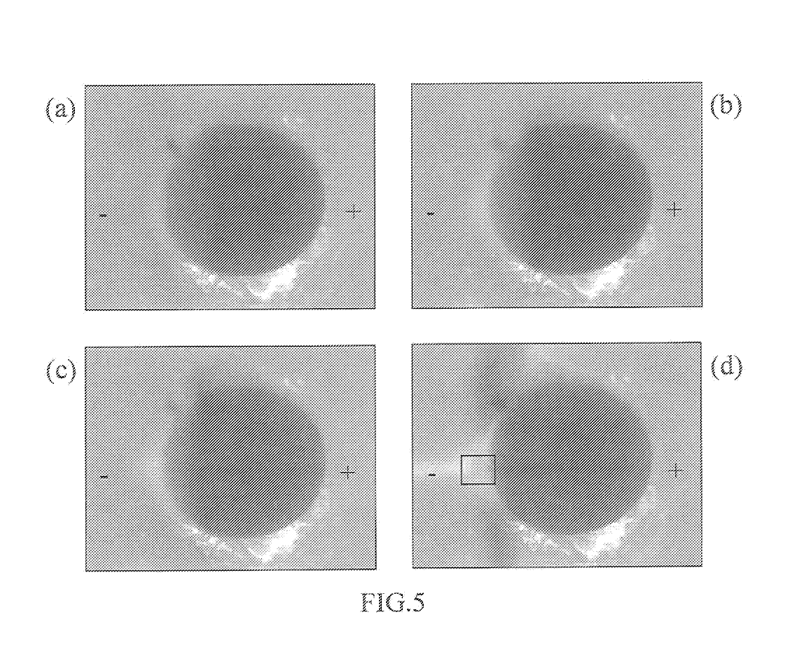

Sequential frames which are taken at 0, 0.36, 0.63, and 0.93 seconds in FIGS. 5a, 5b, 5c, and 5d respectively show the evolution of co-ion (e.g. fluorescein) concentration processes under a step jump in the field strength 100 V/cm for the negatively charged granule with positive counter ions in the double layer. The lapsed frames capture the concentration of the anion dye towards the ejecting hemisphere to form a distinctive rim. The rim then focuses towards the ejecting pole, close to the negative electrode. Upon reaching the ejecting pole, the dye concentrates and emits an intense fluorescent glow for an interval of 0.3 seconds before a violent ejection in the form of a jet occurs in FIG. 5d at 0.93 seconds.

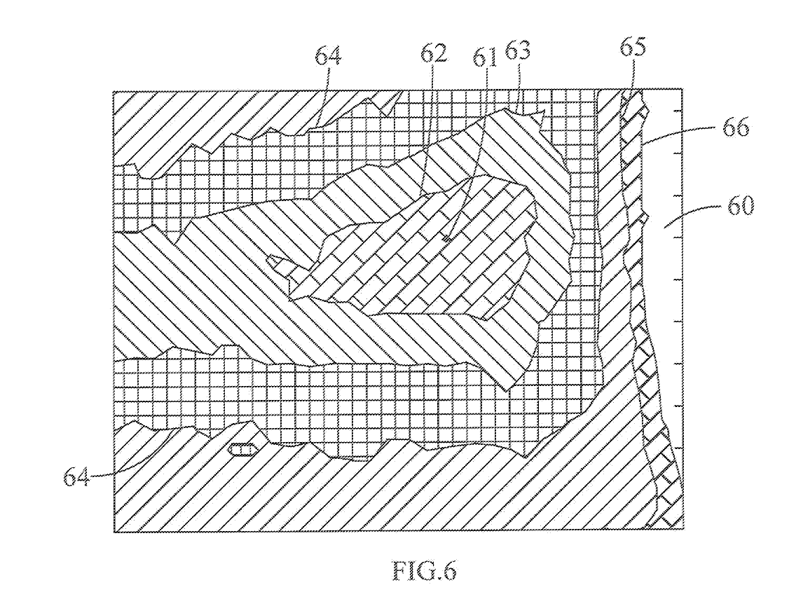

By subtracting the blank background (10 mM Tris buffer; pH 8) and correlating the reduced pixel intensity to the dye concentration, the concentration intensity contour in the region highlighted in FIG. 5d can be quantitatively estimated as FIG. 6. The numbers 61, 62, 63, 64, 65 and 66 on the concentration contour map indicate estimated molar concentrations of the dye, respectively being 0.2, 0.02, 0.002, 0002, 0.00002 and 0.000002. The white area 60 at the right side of the contour is the conducting granule edge marked in the frame of FIG. 5d. The concentration is enhanced by ˜10⁶ and ˜10⁵ times the bulk value at the most concentrated spot and the jet area respectively.

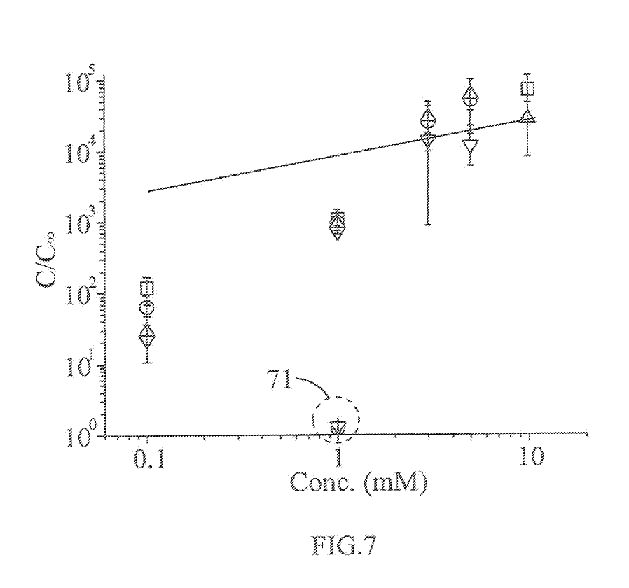

To underscore that ion permeation into the conducting granule is necessary for this 10⁶-fold dynamic super-concentration, which was not observed in earlier steady-state experiments with smaller pores, the experiments at various ionic strengths and with a wax bead 71 of similar dimension are carried out. As seen in FIG. 7, the enhancement factor drops precipitously by one to two orders of magnitude at a concentration 0.1 mM, when the Debye length (i.e. the thickness of the electric double-layer) is estimated to be 30 nm and expected to be comparable to the pore size of the conducting granule. There is no enhancement at all for the wax bead 71 without any pores. The higher conductivity data from 3 to 10 mM produce the 10⁵-fold concentration, suggesting the importance of permeation. When the Debye length is approximately equal to the pore size, the surface field is not screened and counter-ions with affinity for the surface functional groups condense readily onto the surface. As a consequence, the influx counter-ions are no longer able to migrate through the pore and therefore are captured within the conducting granule.

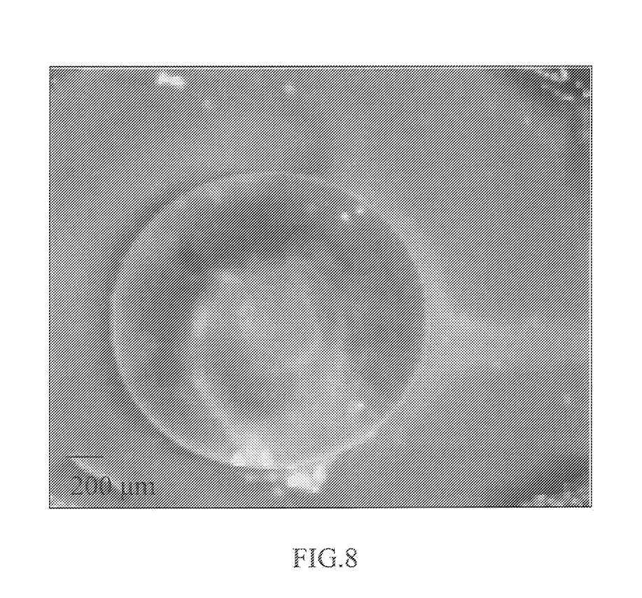

A similar co-ion concentration in the bulk region near the ejecting pole is observed when a positively charged granule is used with cationic dye rhodamine B, as shown in the FIG. 8. In the figure, the polar ejection for the anion exchange granule at 100 V/cm using co-ion rhodamine B dyes (1 μM in 10 mM citrate buffer at pH 4) is taken at 0.96 seconds. Anionic counter-ions are absorbed onto the exit hemisphere to form a rim, which focuses toward the pole and ejects after a delay. The polar concentration and ejection phenomena are symmetric with respect to the conducting granule and double layer polarity.

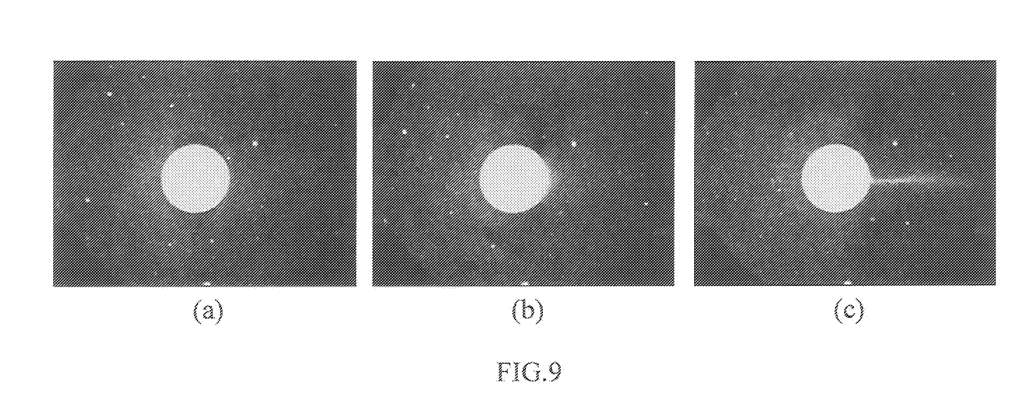

Similarly when a negatively charged conducting granule is in the reservoir, the trapping of anionic microcolloids tagged with fluorescein dyes is seen. The sequential images in FIG. 9 show fluorescein-tagged microcolloids at a very low density (5.0×10⁶ particles/mL) are concentrated with a step change in the field strength 100 V/cm in 10 mM Tris buffer (pH 8) at the ejecting pole of the cation exchange granule. The images are taken at 0, 1.35, and 2.44 seconds. The concentrated particle density is estimated as 1.5×10⁸ particles/mL, as high as 30-fold concentration of the original microcolloids recorded despite their large dimension relative to the double layer and their low mobility, and despite the fact that the microcolloids do not enter or exit the conducting granule. The reflection of the incoming light by the microspheres is much stronger than scattered light from the reservoir bottom in FIG. 3, thus preventing the latter from contaminating the image.

The above argument corresponds to the counter-ion concentration. However, when the concentrated ions are ejected from the ejecting pole, they attract co-ions to achieve neutrality. In fact, both the co-ion tagged microcolloids and the large co-ion fluorescent dye molecules are probably not the ones being concentrated via transit through the granule and tangential surface flux toward the pole. Rather, it is a smaller counter-ion that is so concentrated with the larger co-ion simply tracking the enhanced counterion concentration as the latter ions exit the double layer into the electroneutral bulk. This is why only the co-ion dye or co-ion dye tagged microcolloids are concentrated by the ion-exchange granules.

Moreover, the present invention further studies the concentration effect of fluorescence dyes (e.g. fluorescein) in different pH Values. Firstly, fluorescein fluorescence dyes with a pKa 6.4˜6.8 are dissolved in 10 mM Tris buffers with pH 6, 6.6 and 8, and the absorption values of these fluorescein solutions with pH 6, 6.6 and 8 are respectively measured by a UV-visible spectroscopy at the detection range of 200-800 nm. Then, the dissociation degrees of these fluorescein solutions in the Tris buffers are calculated by using Beer's law. Additionally, the fluorescein solutions with pH 6, 6.6 and 8 are concentrated with a step change in the field strength 100 V/cm at the ejecting pole of the cation exchange granule. The experimental results, as shown in Table 1, show that the higher the dissociation degree of the fluorescein in the Tris buffer, a concentration effect of the fluorescein is better.

TABLE 1

| pH value | 6 | 6.6 | 8 |
|---|---|---|---|
| Dissociation degree | ~0% | 16% | 100% |
| Original concentrating | — | 3.7 | 5 |
| multiplying power | | | |
| (10^{x}-fold) | | | |

Similarly, the concentration effect of proteins (e.g. fluorescein-tagged bovine-serum albumin (BSA)) in different pH values is studied. Firstly, fluorescein-tagged BSA with a pl 4˜5 are dissolved in 15 mM PBS buffers with pH 5, 6, 6.6, 8 and 8.8. Then, these fluorescein-tagged BSA solutions are concentrated with a step change in the field strength 100 V/cm at the ejecting pole of the cation exchange granule. As shown in Table 2, the experimental results show that the higher the pH value of the fluorescein-tagged BSA in the PBS buffer, a concentration effect of the fluorescein-tagged BSA is better. That is, the higher the pH value, the net charges (negative charges) of the BSA increases. Therefore, the higher the number of charges of the particles in the electrolyte solution, a concentration effect of the particles is better.

TABLE 2

| pH value | 5 | 6 | 6.6 | 8 | 8.5 |
|---|---|---|---|---|---|
| Concentrating multiplying | 1.45 | 2.79 | 3.34 | 3.85 | 3.85 |
| power (10^{x}-fold) | | | | | |

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiments of the present invention. In addition, the word “comprising” does not exclude other elements or steps, and the indefinite article “a” or “an” does not exclude a plurality.

What is claimed is:

1. A method for concentrating particles or molecules, comprising the steps of:
providing a substrate comprising a reservoir;
disposing a conducting granule in the reservoir, the conducting granule being negatively charged or positively charged and comprising nano-pores or nano-channels capable of permitting ion permeation;
disposing an electrolyte solution in the reservoir, the electrolyte solution comprising counter-ions having an opposite electric property to the conducting granule;
adding particles or molecules to be concentrated into the electrolyte solution, the particles or molecules having an identical electric property as the conducting granule at a predefined pH value;
adjusting the electrolyte solution to the predefined pH value according to a pl value or a pKa value of the particles or molecules; and
applying an external electric field on the conducting granule;
wherein while the external electric field is applied on the conducting granule, the counter-ions exit from the nano-pores or nano-channels and have a nonuniform concentration on a surface of the conducting granule such that a transient ion super-concentration phenomenon occurs at an ejecting pole on the conducting granule so as to concentrate the particles or molecules.

2. The method according to claim 1, wherein an electric double-layer is formed on the surface of the conducting granule by the counter-ions.

3. The method according to claim 2, wherein pore sizes of the nano-pores and nano-channels are 3-5 times or larger a thickness of the electric double-layer.

4. The method according to claim 1, wherein sizes of the particles or molecules are nano-scale or micro-scale.

5. The method according to claim 1, wherein the higher the number of charges of the particles or a dissociation degree of the molecules in the electrolyte solution, a concentration effect of the particles or molecules is better.

6. The method according to claim 1, wherein a concentration effect of the particles or molecules is independent of viscosity of the particles or molecules.

7. The method according to claim 1, wherein the conducting granule comprises a cation exchange resin granule or an anion exchange resin granule.

8. The method according to claim 7, wherein the particles or molecules comprise fluorescence dyes or proteins.

9. The method according to claim 8, wherein the fluorescence dyes comprise rhodamine, sulforhodamine or fluorescein, and the proteins comprise bovine serum albumin.

10. The method according to claim 9, wherein the predefined pH value of the electrolyte solution is larger than pH 6.6 for the fluorescein with a pKa 6.4˜6.8, and the predefined pH value of the electrolyte solution is larger than pH 5 for the bovine serum albumin with a pl 4˜5 when using the cation exchange resin granule.

11. The method according to claim 1, wherein the method is applicable to a bead-based biomolecular assay.

12. An apparatus for concentrating particles or molecules, comprising:
a substrate, comprising a reservoir;
a conducting granule, being negatively charged or positively charged, comprising nano-pores or nano-channels capable of permitting ion permeation, and disposed in the reservoir;
an electrolyte solution, comprising counter-ions having an opposite electric property to the conducting granule, and disposed in the reservoir; and
an external electric field, applying on the conducting granule;
wherein, particles or molecules to be concentrated have an identical electric property as the conducting granule at a predefined pH value and are added into the electrolyte solution;
the electrolyte solution is adjusted to the predefined pH value according to a pl value or a pKa value of the particles or molecules; and while the external electric field is applied on the conducting granule, the counter-ions exit from the nano-pores or nano-channels and have a nonuniform concentration on the surface of the conducting granule such that a transient ion super-concentration phenomenon occurs at an ejecting pole on the conducting granule so as to concentrate the particles or molecules.

13. The apparatus according to claim 12, wherein an electric double-layer is formed on the surface of the conducting granule by the counter-ions.

14. The apparatus according to claim 13, wherein pore sizes of the nano-pores or nano-channels are 3-5 times or larger a thickness of the electric double-layer.

15. The apparatus according to claim 12, wherein sizes of the particles or molecules are nano-scale or micro-scale.

16. The apparatus according to claim 12, wherein the higher the number of charges of the particles or a dissociation degree of the molecules in the electrolyte solution, a concentration effect of the particles or molecules is better.

17. The apparatus according to claim 12, wherein a concentration effect of the particles or molecules is independent of viscosity of the particles or molecules.

18. The apparatus according to claim 12, wherein the conducting granule comprises a cation exchange resin granule or an anion exchange resin granule.

19. The apparatus according to claim 18, wherein the particles or molecules comprise fluorescence dyes or proteins.

20. The apparatus according to claim 19, wherein the fluorescence dyes comprise rhodamine, sulforhodamine or fluorescein, and the proteins comprise bovine serum albumin.

21. The apparatus according to claim 20 wherein the predefined pH value of the electrolyte solution is larger than pH 6.6 for the fluorescein with a pKa 6.4˜6.8, and the predefined pH value of the electrolyte solution is larger than pH 5 for the bovine serum albumin with a pl 4˜5 when using the cation exchange resin granule.

22. The apparatus according to claim 12, wherein the method is applicable to a bead-based biomolecular assay.
